(19) United States
(12) Patent Application Publication
(10) Pub. No.: US 2018/0010907 A1
(43) Pub. Date: Jan. 11, 2018

(54) Sequential Diffractive Pattern Projection

(71) Applicant: Siemens Aktiengesellschaft, Muenchen (DE)

(72) Inventors: Frank Forster, Muenchen (DE); Anton Schick, Velden (DE); Patrick Wissmann, Muenchen (DE)

(73) Assignee: Siemens Aktiengesellschaft, Muenchen (DE)

(21) Appl. No.: 15/546,487

(22) PCT Filed: Sep. 15, 2015
(86) PCT No.: PCT/EP2015/071011

§ 371 Date: Jul. 26, 2017

(30) Foreign Application Priority Data
Feb. 6, 2015 (DE) 10 2015 202 182.3

(51) Int. Cl. G01B 11/25; G02B 27/42

(52) U.S. Cl. CPC G01B 11/2513; G02B 27/425; G06T 7/521; G01B 11/254; G06T 2207/10028

(57) ABSTRACT

The present disclosure relates to structured illumination. The teachings thereof may be embodied in devices for reconstruction of a three-dimensional surface of an object by means of a structured illumination for projection of measurement patterns onto the object. For example, a device may include: a projector unit for diffractive projection of a measurement pattern comprising a plurality of measurement points onto the surface; an acquisition unit for acquiring the measurement pattern from the surface; and a computer unit for reconstruction of the surface from a respective distortion of the measurement pattern. All possible positions of measurement elements are contained in the measurement pattern in repeating groups, in which a respective combination of measurement points represents a respective location in the measurement pattern.

### CROSS-REFERENCE TO RELATED APPLICATIONS

This application is a U.S. National Stage Application of International Application No. PCT/EP2015/071011 filed Sep. 15, 2015, which designates the United States of America, and claims priority to DE Application No. 10 2015 202 182.3 filed Feb. 6, 2015, the contents of which are hereby incorporated by reference in their entirety.

### TECHNICAL FIELD

The present disclosure relates to structured illumination. The teachings thereof may be embodied in devices and methods for reconstruction of a three-dimensional surface of an object by means of a structured illumination for projection of measurement patterns onto the object.

### BACKGROUND

The method of so-called structured illumination is used in optical metrology. In this method, one or more measurement patterns are projected onto an object and recorded from another angle by a camera. The three-dimensional surface of the object can be reconstructed in the form of measurement points from the distortion of the pattern.

In the metrological method, one or more patterns, which can also be referred to as measurement patterns, are projected onto an object and recorded from another angle by a camera. FIG. 1 shows a conventional minimal configuration, consisting of a camera as an acquisition unit 3 and a projector as a projector unit 1. Point P1 is projected by a pattern projector and appears in the camera image as point P1′. By means of geometrical relationships, the three-dimensional position of P1 in space can be determined if the projection beam path originating from the projector and the viewing beam path originating from the camera are known.

In this case, the correct assignment of projection beam path and viewing beam path are decisive. Because of the plurality of equivalent point projections, a particular locally varying coding is necessary for identification of the point P1 or the differentiation thereof from, for example, point P2 or point P3. FIG. 1 shows a conventional minimal configuration for three-dimensional measurement by means of structured illumination, consisting of a camera and a projector, which are spaced apart from one another at a distance of a base B.

Numerous conventional methods exist for the projection of measurement patterns, as well as numerous design variants of the measurement patterns. These include a subclass of methods, in which the patterns are projected by means of light diffraction, i.e., in a diffractive manner. These methods are particularly light-efficient, but restrict the embodiment of the measurement patterns. In general, numerous points or other shapes, which are referred to hereafter in general as measurement points, are projected, wherein information, which codes the respective location in the measurement pattern, is concealed in the local arrangement and/or shape of the measurement points.

[1] “Video-rate capture of Dynamic Face Shape and Appearance” by Ioannis A. Ypsilos, Adrian Hilton, and Simon Rowe, Centre for Vision Speech and Signal Processing, University of Surrey, Guildford, Gu2 7HX, UK, and Canon Research Centre Europe, Bracknell, Berkshire, RG12 2HX, UK, 2004 is an example that the information can result by a random arrangement, which does not repeat multiple times in the pattern, of the measurement points.

[2] “A Low Cost Structured Light System” by Mario L. L. Reiss, Antonia M. G. Tommaselli, Christiane N. C. Kokubum, Sao Paulo State University, Rua Roberto Simonsen, 305, Pres. Prudente, SP, Brazil, 19060-900, Presidente Prudente, Sao Paulo, 2005 and [3] “Range Image Acquisition with a Single Binary Encoded Light Pattern” by P. Vuylsteke and A. Oosterlinck, from IEEE Transaction on Pattern Analysis and Machine Intelligence, pages 148 et seq., Vol. 12, No. 2, February 1990, disclose variants in which the information is located in the form of the measurement points.

[4] U.S. Pat. No. 7,433,024 B2 discloses that this information can also be contained in patterns, in particular speckled patterns variable in all three dimensions, and especially here via the distance to the projector.

[5] U.S. Pat. No. 5,548,418 and [6] WO 2007/043036 A1 disclose a device for projection of patterns by means of diffractive optical elements and the use thereof in 3D metrology.

### SUMMARY

The teachings of the present disclosure may be embodied in devices and methods for reconstruction of a three-dimensional surface of an object by means of a structured illumination for projection of measurement patterns onto the object, wherein the projection is to be executable rapidly, cost-effectively, and light-efficiently. Measurement patterns are to be high-performance with respect to robust decoding capability and in particular with respect to the number of the measurement elements, i.e., with respect to the data density.

For example, some embodiments may include a device for reconstruction of a surface of an object (O) by means of a structured illumination, the device comprising: at least one projector unit (1) for diffractive projection of at least one measurement pattern (MM1, MM2, MM3), comprising measurement elements, in particular measurement points (P), onto the surface of the object; at least one acquisition unit (3) for acquiring the measurement pattern (MM1, MM2, MM3) on the surface of the object; a computer unit (5) for reconstruction, in particular executed by means of triangulation, of the surface of the object from a respective distortion of the measurement pattern, characterized in that all possible positions of measurement elements are contained in the measurement pattern in repeating groups (G), in which a respective combination of generated and/or non-generated measurement elements represents or codes the respective location in the measurement pattern.

In some embodiments, the projector unit (1) projects the measurement pattern as a chronological sequence of measurement patterns (MM1, MM2, MM3) onto the surface of the object, wherein the chronological sequence of the measurement patterns (MM1, MM2, MM3) forms an overall pattern (GM) when superimposed.

In some embodiments, the projector unit (1) additionally represents the respective location in the measurement pattern in the groups by means of a respective light wavelength of measurement elements.

In some embodiments, the projector unit (1) generates the measurement pattern as a concatenation of hexagonal geometric basic shapes.

In some embodiments, the projector unit (1) always generates all measurement elements (P) in at least one measurement pattern (MM1) of the chronological sequence.

In some embodiments, the projector unit (1) generates the chronological sequence of three measurement patterns (MM1, MM2, MM3), wherein one measurement element (P) is always generated in each group from one measurement pattern (MM1) of the chronological sequence and at most two measurement elements (P) are generated from each of the two other measurement patterns (MM2, MM3) of the chronological sequence.

In some embodiments, the projector unit (1) provides a maximum number of greater than four generated or non-generated measurement elements (P) within the plurality of groups (G).

In some embodiments, the projector unit (1) only provides codings having a minimum number of generated and non-generated measurement elements within the plurality of groups (G).

In some embodiments, the projector unit (1) generates the groups (G) overlapping such that a number of measurement elements is both part of a group k and also part of an adjacent group k+1 or k−1.

In some embodiments, the projector unit (1) generates a sequence of adjacent groups (G) as a word (W).

In some embodiments, the projector unit (1) generates the entirety of all adjacent groups as a sequence or as the overall pattern (GM).

In some embodiments, the projector unit (1) generates a word (W) within a sequence or an overall pattern (GM) only often enough that the correspondence problem is uniquely solvable on the basis of geometric framework conditions between camera and projector, in particular by means of epipolar geometry.

In some embodiments, the projector unit (1) generates one word (W1) differently from another word (W2) in at least two groups (G).

In some embodiments, the projector unit (1) comprises, in a spatially separated manner, a light source (L), a beam-forming optic, and a diffractive optical element (DOE) for each measurement pattern (MM1) consisting of measurement elements (P).

In some embodiments, the projector unit (1) comprises, in a spatially compiled manner, at least one light source (L1, L2, L3), at least one beam-forming optic (7), and at least two mechanically replaceable diffractive optical elements (DOE1, DOE2, DOE3) for all measurement patterns (MM1, MM2, MM3) consisting of measurement elements (P).

In some embodiments, the projector unit (1) comprises at least one diffractive optical element (DOE), from which a filter unit, in particular a light trap (9) or deflection unit, for absorption and/or reflection of at least the zero-order diffraction, is arranged downstream in the downstream beam path.

In some embodiments, the filter unit is spaced apart from the diffractive optical element such that a separation of the measurement elements occurs before the filter unit.

In some embodiments, the numeric aperture and the beam waist are adapted in the meaning of a Gaussian beam of the projector unit (1) such that the radius (r_{b}) of a projected beam (S2) is smaller than the radius (r_{c}) of a camera pixel in the object space at least over the required depth of field range, in particular between approximately 800 mm and 1200 mm.

In some embodiments, the projector unit (1), to increase a measurement element density by means of a chronologically varying displacement of a respective measurement pattern (MM1, MM2, MM3), in particular of the chronological sequence, comprises rotationally or translationally actuated components, in particular a scanning mirror (SM).

As another example, some embodiments may include a method for reconstruction of a surface of an object (O) by means of a structured illumination, by means of the following steps: diffractive projection, executed by means of at least one projector unit (1), of at least one measurement pattern (MM1, MM2, MM3), comprising measurement elements, in particular measurement points (P), onto the surface of the object; acquisition, executed by means of at least one acquisition unit (3), of the measurement pattern (MM1, MM2, MM3) on the surface of the object; computation, executed by means of a computer unit (5), in particular triangulation, for reconstruction of the surface of the object from a respective distortion of the measurement pattern, characterized in that all possible positions of measurement elements are contained in the measurement pattern in repeating groups (G), in which a respective combination of generated and/or non-generated measurement elements represents or codes the respective location in the measurement pattern (GM).

In some embodiments, the projector unit (1) projects the measurement pattern as a chronological sequence of measurement patterns (MM1, MM2, MM3) onto the surface of the object, wherein the chronological sequence of the measurement patterns (MM1, MM2, MM3) forms an overall pattern (GM) when superimposed.

In some embodiments, the projector unit (1) additionally represents the respective location in the measurement pattern in the groups by means of a respective light wavelength of measurement elements.

In some embodiments, the projector unit (1) generates the measurement pattern as a concatenation of hexagonal geometric basic shapes.

In some embodiments, the projector unit (1) always generates all measurement elements (P) in at least one measurement pattern (MM1) of the chronological sequence.

In some embodiments, the projector unit (1) generates the chronological sequence of three measurement patterns (MM1, MM2, MM3), wherein one measurement element (P) is always generated in each group from one measurement pattern (MM1) of the chronological sequence and at most two measurement elements (P) are generated from each of the two other measurement patterns (MM2, MM3) of the chronological sequence.

In some embodiments, the projector unit (1) provides a maximum number of greater than four generated or non-generated measurement elements (P) within the plurality of groups (G).

In some embodiments, the projector unit (1) only forms codings having a minimum number of generated and non-generated measurement elements within the plurality of groups (G).

In some embodiments, the projector unit (1) generates the groups (G) overlapping such that a number of measurement elements is both part of a group k and also part of an adjacent group k+1 or k−1.

In some embodiments, the projector unit (1) generates a sequence of adjacent groups (G) as a word (W).

In some embodiments, the projector unit (1) generates the entirety of all adjacent groups as a sequence or as the overall pattern (GM).

In some embodiments, the projector unit (1) generates a word (W) within a sequence or an overall pattern (GM) only often enough that the correspondence problem is uniquely solvable on the basis of geometric framework conditions between camera and projector, in particular by means of epipolar geometry.

In some embodiments, the projector unit (1) generates one word (W1) differently from another word (W2) in at least two groups (G).

In some embodiments, the projector unit (1) removes at least the zero-order diffraction, in particular by absorption or reflection, from the measurement space in the downstream beam path of a diffractive optical element (DOE) by means of a filter unit, in particular a light trap (9) or deflection unit.

In some embodiments, the numeric aperture and the beam waist are adapted in the meaning of a Gaussian beam of the projector unit (1) such that the radius (r_{b}) of a projected beam (S2) is smaller than the radius (r_{c}) of a camera pixel in the object space at least over the required depth of field range, in particular between approximately 800 mm and 1200 mm.

In some embodiments, the projector unit (1), to increase a measurement element density, executes a chronologically varying displacement of a respective measurement pattern (MM1, MM2, MM3), by means of rotationally or translationally actuated components, in particular a scanning mirror (SM).

### BRIEF DESCRIPTION OF THE DRAWINGS

The teachings of the present disclosure will be described in greater detail on the basis of exemplary embodiments in conjunction with the figures. In the figures:

FIG. 1 shows an exemplary embodiment of a conventional device;

FIG. 2 shows a first exemplary embodiment of a conventional overall pattern;

FIG. 3 shows further exemplary embodiments of conventional overall patterns;

FIG. 4 shows a first exemplary embodiment of an overall pattern according to the teachings of the present disclosure;

FIG. 5 shows an exemplary embodiment of groups according to the teachings of the present disclosure;

FIG. 6 shows a further exemplary embodiment of groups according to the teachings of the present disclosure;

FIG. 7 shows further exemplary embodiments of measurement patterns according to the teachings of the present disclosure;

FIG. 8 shows a first exemplary embodiment of a device according to the teachings of the present disclosure;

FIG. 9 shows a second illustration of the first exemplary embodiment of a device according to the teachings of the present disclosure;

FIG. 10 shows a second exemplary embodiment of a device according to the teachings of the present disclosure;

FIG. 11 shows a third exemplary embodiment of a device according to the teachings of the present disclosure;

FIG. 12 shows an illustration of the setting of a projector unit according to the teachings of the present disclosure;

FIG. 13 shows two further exemplary embodiments of devices according to the teachings of the present disclosure;

FIG. 14 shows an exemplary embodiment of a method according to the teachings of the present disclosure.

### DETAILED DESCRIPTION

In some embodiments, there is a device for reconstruction of a surface of an object by means of a structured illumination, which comprises at least one projector unit for diffractive projection of a measurement pattern, comprising measurement elements, in particular measurement points, onto the surface of the object, at least one acquisition unit for acquiring the measurement pattern on the surface of the object, and a computer unit for reconstruction, in particular executed by means of triangulation, of the surface of the object from a respective distortion of the measurement pattern, wherein all possible positions of measurement elements are compiled or represented or contained in the measurement pattern in repeating groups, in which a respective combination of actually generated and/or non-generated measurement elements represents or codes the respective location in the measurement pattern.

In some embodiments, there is a method for reconstruction of a surface of an object by means of a structured illumination by means of the following steps, specifically diffractive projection, executed by means of at least one projector unit, of a measurement pattern, comprising measurement elements onto the surface of the object, acquisition, executed by means of at least one acquisition unit, of the measurement pattern on the surface of the object, and reconstruction, in particular by means of triangulation, which is executed by means of a computer unit, of the surface of the object from a respective distortion of the measurement pattern, wherein all possible positions of measurement elements or measurement points are contained in the measurement pattern in repeating groups, in which a respective combination of generated and/or non-generated measurement elements represents or codes the respective location in the overall pattern. This means, in the groups, a respective combination of provided and/or non-provided measurement elements codes the respective location in the measurement pattern.

Measurement elements form a respective measurement pattern and can fundamentally each comprise an arbitrary surface form. In some embodiments, measurement elements are measurement points, in particular uniform measurement points. Measurement elements can be generated by means of light of respective light beams. A group forms a repeating base unit, in which an entirety of possible positions of measurement elements is contained. In the actual measurement pattern, measurement elements do not actually have to be physically generated at all possible positions of measurement elements.

In contrast to imaging projection, wherein the projected pattern is predominantly generated by means of light refraction, i.e., in a refractive manner, in diffractive projection, the pattern is predominantly generated by means of diffraction, specifically in general by means of so-called diffractive optical elements (DOEs). The diffractive projection of measurement patterns is particularly light-efficient, but restricts the design of the measurement patterns. In diffractive projection, in general point patterns are used, because they are well reproducible using DOEs.

In principle, measurement patterns can alternatively comprise arbitrary measurement subunits, which can comprise other surface forms, for example, which can be triangles, squares, or rectangles, for example. The measurement elements mentioned in this application therefore also comprise all possible planar embodiments of measurement subunits or measurement shapes, for example, measurement points. The density of the measurement elements or measurement subunits or measurement points in the measurement space is limited by the resolution of the cameras which are used for the analysis. If the point density is designed as excessively high, measurement elements can possibly no longer be reliably differentiated.

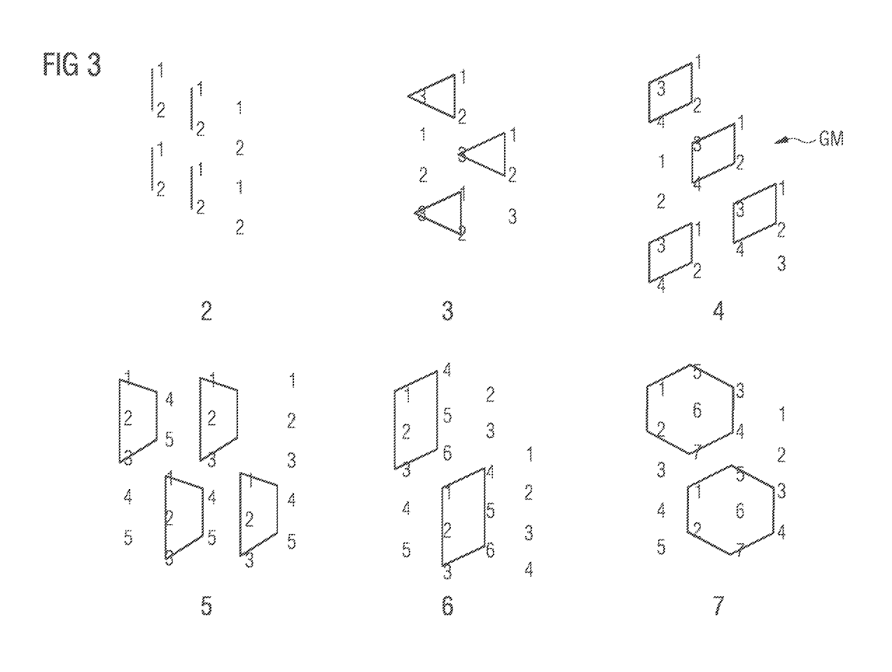

A further limit is in the optical information capacity of the diffractive optical elements. Arbitrarily complex patterns cannot be reproduced in any arbitrary resolution. The maximum possible point density generally cannot be exhausted, because the arrangement of the points has to bear items of information for decoding the pattern. In the case of a completely occupied pattern, for example, at the maximum point density, the pattern would not bear such items of information, this means the pattern would not be locally unique, but rather would be uniform or periodic. Such patterns are shown in FIGS. 2 and 3.

However, the local uniqueness is required, because a relationship between the origin of a respective projected beam and the viewing beam of one or more cameras or acquisition units has to be established for 3D reconstruction by means of triangulation, which is referred to as the correspondence problem. In practice, not all resolvable points are projected for the locally varying coding of the information. However, this results in a reduced number of resolvable measurement elements or measurement points, because they can only be ascertained at the location of a projected element or point.

One technical option for increasing the point density is the chronologically successive, sequential projection of multiple measurement patterns. The chronological variation of the measurement patterns then offers an additional information channel for the decoding of the pattern, so that it is possible if necessary to achieve the maximum possible point density, which is limited by the camera resolution.

Some embodiments include coding a locally varying item of information in the measurement pattern, for solving the correspondence problem. Chronological and/or positional coding is performed by means of active and inactive measurement elements in the measurement pattern, wherein inactive refers here to the omission of measurement elements in an otherwise fully occupied grid. The compilation of measurement elements into groups, which correspond to symbols, wherein the symbol index is coded by omission of points, enables a solution of the correspondence problem by means of non-periodic measurement patterns while maintaining a high measurement element density, wherein the grouping results in a longer symbol alphabet having a plurality of possible symbols, whereby decoding can be made more error-tolerant.

In some embodiments, the projector unit (1) can project the measurement pattern as a chronological sequence of measurement patterns (MM1, MM2, MM3) onto the surface of the object, wherein the chronological sequence of the measurement patterns (MM1, MM2, MM3) forms an overall pattern (GM) or a sequence when superimposed.

In some embodiments, the projector unit can additionally code or represent the respective location in the measurement pattern in the groups by means of a respective light wavelength of measurement elements. Therefore, a chronological and/or positional coding can additionally be executed by means of measurement elements of different wavelengths.

In some embodiments, the projector unit can generate the overall pattern as a concatenation of hexagonal geometric basic shapes. An arrangement of measurement elements in a measurement pattern sequence in concatenation of hexagonal, geometric basic shapes enables a maximally dense packing of the cumulative measurement elements with simultaneously homogeneous distribution over the entirety of the measurement pattern sequence, and in particular with the best possible utilization of a resolution of the acquisition unit or the camera.

In some embodiments, the projector unit can always generate all measurement elements as provided in at least one measurement pattern of the chronological sequence. The use of a measurement pattern which is always fully occupied can be utilized for localization of point pattern groups or for synchronization of the decoding, so that a higher level of robustness of the decoding and more uniform measurement element distribution result.

In some embodiments, the projector unit can generate the chronological sequence of three measurement patterns, wherein one measurement element can always be provided in each group from one measurement pattern of the chronological sequence and at most two measurement elements can be provided from each of the two other measurement patterns of the chronological sequence.

In some embodiments, the projector unit can generate a maximum number of greater than four provided or non-provided measurement elements within the plurality of groups.

In some embodiments, the projector unit can only form codings having a minimum number of generated or non-generated measurement elements within the plurality of groups. In other words, the projector unit can only provide codings having a minimum number of generated and non-generated measurement elements within the plurality of groups. An omission of symbols having low measurement element occupation advantageously causes a higher number of measurement elements in the overall pattern or in the sequence, respectively.

In some embodiments, the projector unit can generate the groups overlapping such that a number of measurement elements can be both part of a group k and also part of an adjacent group k+1 or k−1. These overlapping symbol bits can be used for error correction, from which a higher level of robustness of the decoding results.

In some embodiments, the projector unit can generate a sequence of adjacent groups, which can be referred to as a word.

In some embodiments, the projector unit can generate the entirety of all adjacent groups, which can be referred to as the overall pattern or as a sequence.

In some embodiments, the projector unit generates a word within an overall pattern or a sequence only often enough that the correspondence problem is uniquely solvable on the basis of geometric framework conditions between camera and projector. This causes a unique positional coding and determination.

In some embodiments, the projector unit generates one word differently from another word in at least two groups. Uniqueness of an item of location information can be improved in this manner.

In some embodiments, the projector unit can comprise, in a spatially separated manner, a light source, a beam-forming optic, and a diffractive optical element for each measurement pattern consisting of measurement elements. In this manner, a use of laser arrays each having one diffractive projection optic per laser causes a high-performance and light-efficient and cost-efficient projection of pattern sequences with rapid projection cycles and pattern changes.

In some embodiments, the projector unit can comprise, in a spatially compiled manner, for measurement patterns comprising all measurement elements, at least one light source, at least one beam-forming optic, and at least two mechanically replaceable diffractive optical elements.

In some embodiments, the projector unit can comprise at least one diffractive optical element, from which a filter unit, in particular a light trap for absorption and/or a deflection unit for reflection of at least the zero-order diffraction can be arranged downstream in the downstream beam path. The use of a light trap for elimination of the zero order of diffraction causes a higher, more eye-safe luminous flux in measurement elements or measurement points, so that a better signal-to-noise ratio results in measurement data.

In some embodiments, the filter unit can be spaced apart from the diffractive optical element such that a separation of the measurement elements or measurement points occurs before the filter unit.

In some embodiments, the numeric aperture and the beam waist can be adapted in the meaning of a Gaussian beam of the projector unit such that the radius of a projected beam is smaller than the radius of a camera pixel in the object space at least over the required depth of field range, in particular between approximately 800 and 1200 mm. An adaptation of the waist of a Gaussian beam to the object space camera resolution over the entire depth of field range will advantageously result in more accurate localization of measurement elements or measurement points, so that a better signal-to-noise ratio results.

In some embodiments, the projector unit, to increase a measurement element density or measurement point density by means of a chronologically varying displacement of a respective measurement pattern of the chronological sequence, can comprise rotationally or translationally actuated components, in particular a scanning mirror.

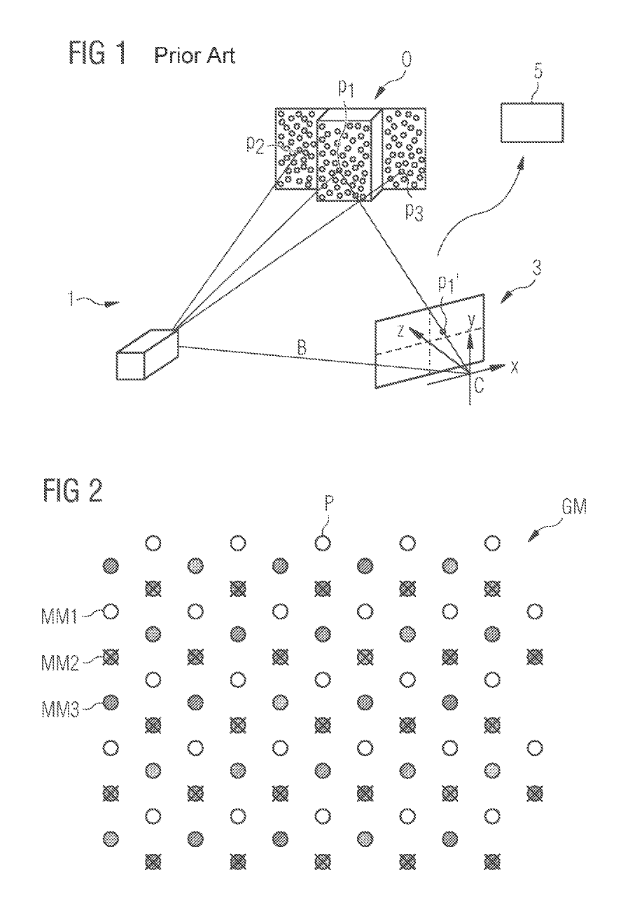

FIG. 1 shows an exemplary embodiment of a conventional device for the reconstruction of a surface of an object O by means of a structured illumination. The device comprises a projector unit 1 for diffractive projection of measurement patterns MM1, which consist of measurement elements, in particular measurement points P, onto the surface of the object. An acquisition unit 3, which can be a camera, for example, acquires the measurement pattern, points P1, P2, and P3 here, on the surface of the object O. By means of a computer unit 5, the surface of the object O can be reconstructed by means of a triangulation from a respective distortion of a measurement pattern or the measurement pattern. B refers to a so-called base, i.e., this is a distance section between projector unit 1 and the zero point or the origin of the coordinate system of the acquisition unit 3.

FIG. 2 shows a first exemplary embodiment of a conventional overall pattern. FIG. 2 shows an arrangement of measurement points P in an overall pattern GM, which can also be referred to as a measurement pattern sequence, wherein a length 3 is generated as a result of a superposition of three measurement patterns MM1, MM2, MM3. The advantage of this overall pattern GM is a maximal dense packing of the points P of the respective pattern with a simultaneously homogeneous distribution over the entirety of the measurement pattern sequence or over the overall pattern GM.

A chronological sequence of measurement patterns MM1, MM2, MM3 . . . results in an overall pattern GM upon the superposition thereof, which can also be referred to as a measurement pattern sequence due to the chronological sequence of the measurement patterns. FIG. 2 shows an exemplary embodiment of a conventional overall pattern GM or a conventional measurement pattern sequence. FIG. 2 shows the arrangement of projected measurement points of an overall pattern GM or a measurement pattern sequence of the length 3 with a maximum cumulative point density.

FIG. 3 shows further exemplary embodiments of conventional overall patterns GM. FIG. 3 shows an arrangement of projected measurement points of an overall pattern GM or a measurement pattern sequence, specifically the lengths 2 to 7 with a maximum cumulative point density. Lines in FIG. 3 identify repeating geometric basic shapes in the arrangement. Small numbers identify the location of a pattern point and its assignment to one of the to 7 patterns in the respective sequence or in the overall pattern GM. The two exemplary embodiments of conventional sequences or overall patterns according to FIGS. 2 and 3 do not contribute to the solution of the correspondence problem, because the cumulative pattern is uniform or periodic. In this manner, coding of a locally varying item of information in the measurement pattern is not executable.

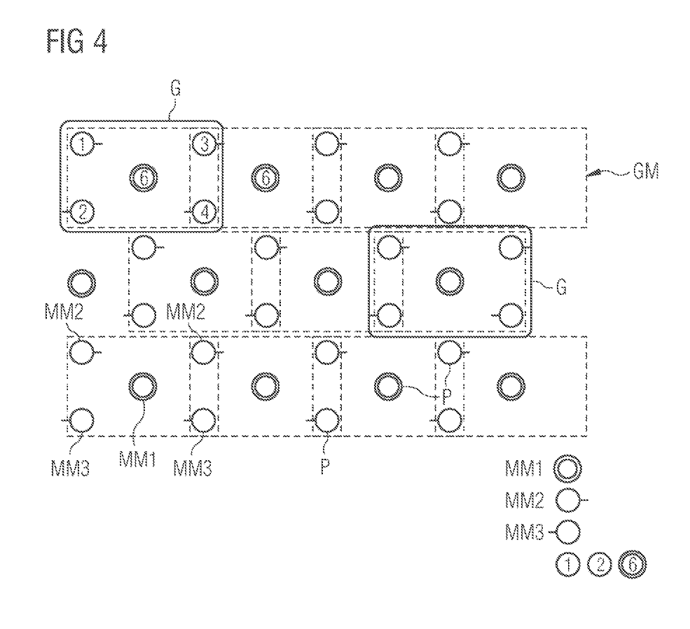

FIG. 4 shows a first exemplary embodiment of an overall pattern GM according to the teachings of the present disclosure. FIG. 4 shows a possible embodiment of an approach in which a chronological or positional coding is executed by means of active and inactive measurement points or measurement elements in the measurement pattern, wherein inactive refers here to the omission of measurement points in an otherwise fully occupied grid. According to FIG. 4, three measurement patterns MM1, MM2, and MM3 are superimposed, so that a sequence length of 3 results. The measurement elements or measurement points are considered in grouped form according to FIG. 4, wherein each group corresponds to a so-called symbol of a sequence of locally unique so-called code words. The numbers in a respective measurement point refer to a respective location point index. According to this exemplary embodiment, the first pattern MM1 of the chronological sequence of the measurement patterns remains fully occupied, i.e., points having the maximum point density are projected in this pattern. This may improve an analyzing algorithm, which can be applied in a computer unit 5, because these points can be presumed to be definitively provided and can therefore be used for localizing the point groups and synchronizing the subsequent decoding. The measurement patterns MM2 and MM3 code the symbol, wherein four bits are provided per symbol in this manner. FIG. 4 shows a layout of a pattern sequence or an overall pattern GM of the length 3. A compilation of the measurement points P into groups G, which correspond to symbols or code words, is performed.

The respective circle shape or circle-cross shape of a measurement point P represents the origin of the measurement point here, specifically whether it belongs to the measurement pattern MM1, MM2, or MM3. The number in the respective measurement point P denotes the respective local numbering of a measurement point P within the group G. The points P of the first measurement pattern MM1 are always provided and can be used as a synchronization channel. Each group consists, according to the exemplary embodiment according to FIG. 4, of a maximum of five points, wherein one point can always originate from the pattern MM1 and at most two points can originate in each case from the measurement pattern MM2 and the measurement pattern MM3. In the overall pattern, each measurement point is the center point of a hexagon here, which is formed from each six adjacent measurement points. This is a particularly dense arrangement of measurement elements.

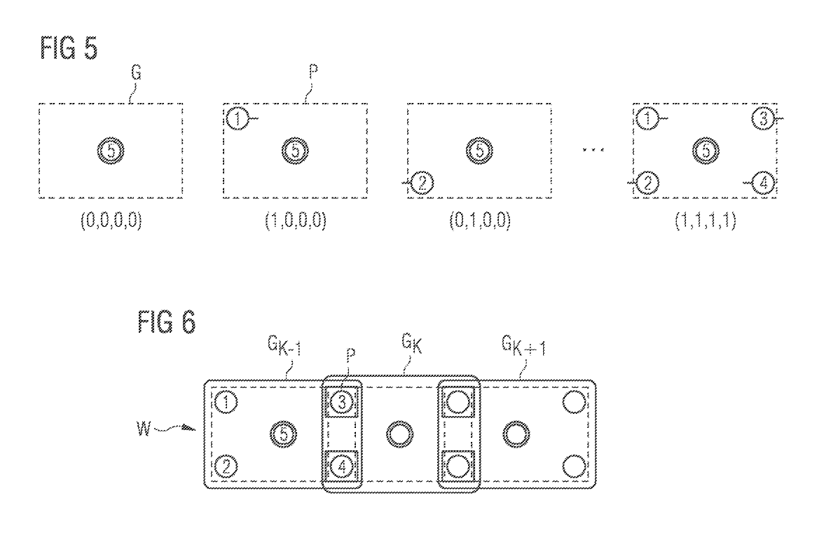

FIG. 5 shows an exemplary embodiment of a group G according to the teachings of the present disclosure. Each group G consists of at most five points P, wherein one point can always be generated by the first measurement pattern MM1 and at most two further measurement points P can be generated in each case by the second measurement pattern MM2 and the third measurement pattern MM3. These combinations of active and inactive points or of represented and omitted points form an alphabet of so-called symbols, as shown according to FIG. 5. According to this exemplary embodiment, up to 2⁴=16 symbols can be formed. FIG. 5 shows an alphabet of up to 16 symbols, which can be formed by means of active and/or inactive points, which can be referred to as symbol bits. One of the patterns, specifically the first measurement pattern MM1, is fully occupied here. Each group G of measurement points P can generate a 3D measurement coordinate with correct decoding for each of its points P. In some embodiments, the device may control as many active points P as possible within the plurality of groups G of the overall measurement pattern sequence or the overall pattern GM. The number of points P can be increased by not using all theoretically possible symbols, which can be 16 items here, but rather, for example, only those which contain a minimum number of active points, for example, 3 active points P.

FIG. 6 shows a further exemplary embodiment of an overall pattern GM according to the teachings of the present disclosure. FIG. 6 shows that a further framework condition is in an overlap of groups G. Multiple points P, which are at most two according to this exemplary embodiment, are both part of a group k and also part of an adjacent group k+1 or k−1, respectively. Therefore, arbitrary sequences of symbols cannot be implemented, specifically only those in which the symbol bits shared by two adjacent groups G correspond. However, this knowledge can be used in the analysis of the groups for error correction, by comparing the shared bits of adjacent groups. FIG. 5 shows an overlap of groups G or of symbol bits.

Each sequence of adjacent symbols or groups G forms a so-called word W, in particular a code word. The entirety of concatenated symbols or groups G forms the so-called sequence, in particular a code sequence, which can also be referred to as an overall pattern GM. It is generally necessary for each word W to have only a maximum number of occurrences within the sequence, so that the correspondence problem can be solved robustly. If a word W occurs in identical form more than once in the sequence, the utilization of geometric framework conditions, for example, of the measurement range, and optionally the application of heuristics is necessary to solve the correspondence problem uniquely. It is generally advantageous if a minimum number>=2 of symbols are different between the words W, so that error recognition or even error correction is executable before the decoding.

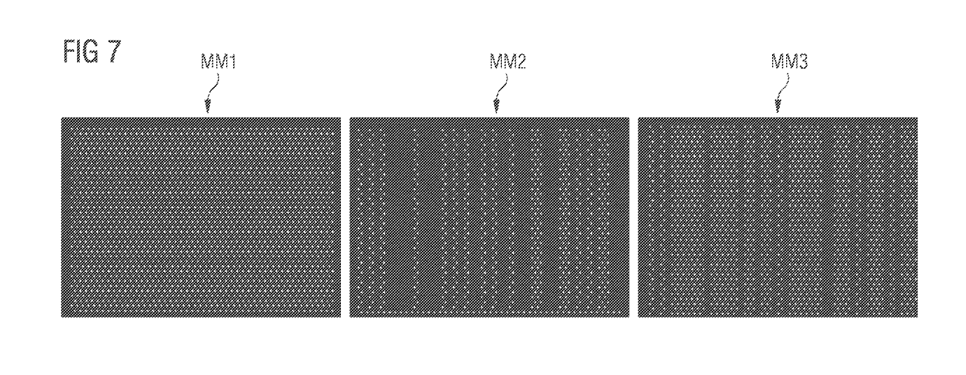

FIG. 7 shows exemplary embodiments of measurement patterns according to the teachings of the present disclosure. FIG. 7 shows as an exemplary embodiment an overall pattern GM or a pattern sequence having the length 3 in consideration of the framework conditions described in conjunction with FIGS. 4, 5, and 6. FIG. 7 explicitly shows the first measurement pattern MM1, the second measurement pattern MM2, and the third measurement pattern MM3, which can all be superimposed to form an overall pattern GM. Length 3 means that three measurement patterns are superimposed.

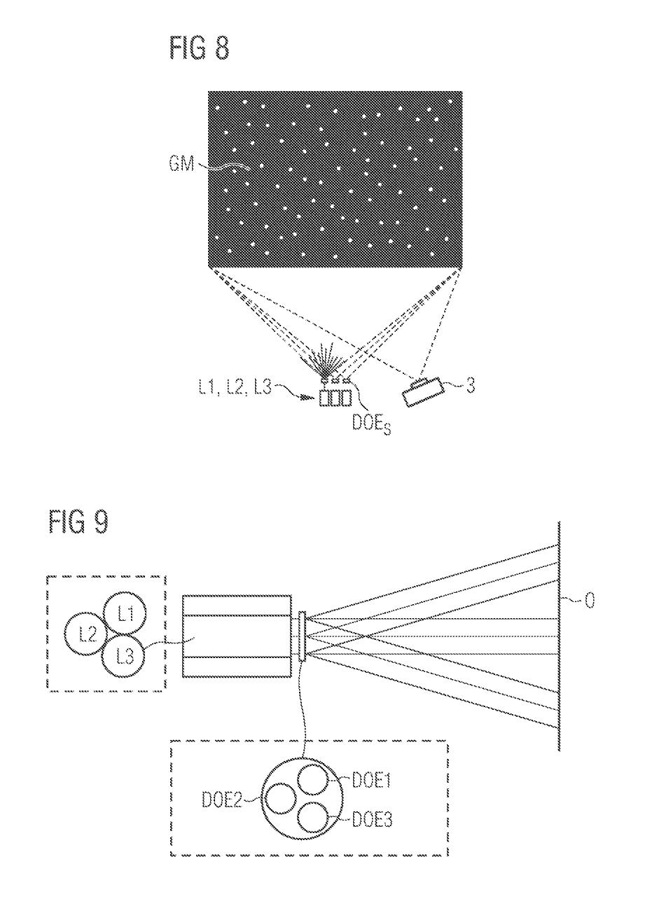

FIG. 8 shows an exemplary embodiment of a device according to the teachings of the present disclosure for reconstruction of a surface of an object O by means of structured illumination. The projection of a measurement pattern sequence or an overall pattern GM, as was described in conjunction with FIGS. 4, 5, 6, and 7, can be executed in various ways. According to a first way, a spatially separated arrangement of multiple assemblies, each having a light source, a beam-forming, for example, collimating optic, and a diffractive optical element DOE can be provided. In some embodiments, an assembly having at least one light source, at least one beam-forming optic, and at least two mechanically replaceable DOEs can be provided. L1, L2, and L3 are three separate light sources in FIG. 8, which, by means of diffractive optical elements DOEs, project an overall pattern GM, which an acquisition unit 3 can record. FIG. 8 shows the exemplary embodiment having a 3D measurement system having diffractively projecting triple laser array L1, L2, and L3 and a camera as the acquisition unit 3. The overall pattern GM or a plurality of measurement patterns MM can be projected on the object O by means of diffractive projection.

FIG. 9 shows a side view of the device according to the teachings of the present disclosure according to FIG. 8. In this case, the three lasers L1, L2, and L3 are shown both in a top view and also in a side view. FIG. 9 shows three mechanically replaceable diffractive optical elements DOEs, which are replaceably positioned in a support unit.

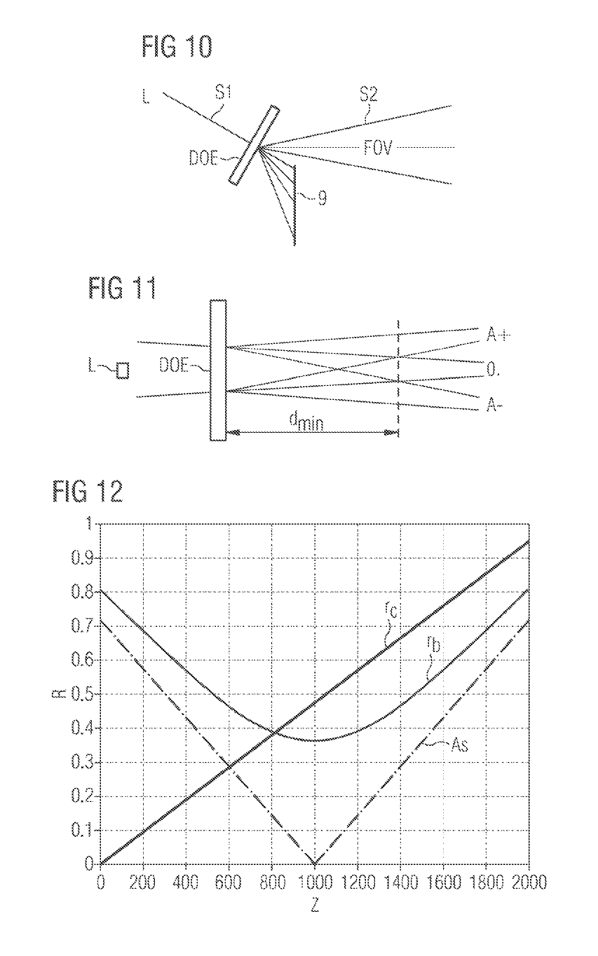

FIG. 10 shows a further exemplary embodiment of a device according to the teachings of the present disclosure. A light source L emits a light beam S1 in the direction toward a diffractive optical element DOE, wherein a light trap 9 for creating a determined field of vision is arranged downstream thereof. Light beams S2 which are not blanked out are visible in the field of vision FOV. To achieve a sufficient signal-to-noise ratio for the analysis, it is advantageous to maximize the luminous flux introduced into the projected points P. The luminous flux resulting in a point P is substantially dependent on the power of the light source, which can be a laser, for example, the diffraction efficiency of the diffractive optical element DOE, and the size of the luminous flux in the zero-order diffraction. This is shown in FIG. 10. The zero-order diffraction is generally minimized in the development of a diffractive optical element DOE.

The development and production costs of a DOE generally increase the more effort is made to suppress the zero-order diffraction. The luminous flux emitted in the zero order is often limiting around the optical power density resulting therefrom, in the meaning of eye safety, i.e., the power of the light source must be adapted so that the optical power density in the zero order is permissible for the desired protection class. The zero order is generally the brightest point in the projected pattern, with 0.2 to 3% of the introduced power. At least one order of magnitude often lies between the zero order and desired pattern points.

FIG. 10 shows an exemplary embodiment of a device according to the teachings of the present disclosure which comprises a DOE and a so-called light trap 9, which shades the zero order. The light trap 9 is positioned in the beam path so that it absorbs at least the zero order and optionally a greater proportion of the projected pattern or deflects them by means of reflection. In principle, multiple replaceable DOEs can be moved replaceably by means of a shared DOE support into the beam path S1 of the light source L. In the embodiment according to FIG. 10, at least 50% of the projected measurement pattern is screened, to remove the zero order from the projected image. Arrangements are also possible which screen a smaller proportion of the pattern.

FIG. 11 shows an illustration of the exemplary embodiment of the device according to the teachings of the present disclosure according to FIG. 10, specifically such that it is to be noted with respect to the positioning of the light trap 9 in the beam path S1 that a respectively sufficient distance to the diffractive optical element DOE should be provided, so that a separation of the measurement elements, for example, measurement points, of the projected pattern has already taken place.

FIG. 11 shows the minimum distance dₘᵢₙ of the beam trap 9 to the diffractive optical element DOE based on the required geometrical separation of measurement elements of the pattern projection. A+ and A− identify desired projections, between which the beams of the zero order extend. A light source L is indicated on the left in FIG. 11. Because generally the eye safety limits the luminous flux in the zero order and therefore in the desired points, and not the maximum possible power of the light source from the diffractive optical element DOE, a higher eye-safe luminous flux can be implemented in the desired points P using the device according to FIG. 10.

FIG. 12 shows an illustration for setting a projector unit 1 according to the teachings of the present disclosure. With respect to the design of light source L and beam-forming components, which are DOEs, for example, it is advantageous to achieve a positional resolution of the projected measurement elements or measurement points in the object space which, over the entire workspace, corresponds at least to the resolution of the acquisition unit 3 or the camera.

FIG. 12 shows, for a given wavelength A=830 nm, the radii of a camera pixel r_{c} and a projected beam r_{b} in the object space, plotted over the distance Z to camera or projector. The numeric aperture or the beam waist in the meaning of a Gaussian beam was adapted on the projection side so that the radius of the projected beam r_{b}, at least over the required depth of field range, which is between 800 and 1200 mm here, remains smaller than the radius of a camera pixel r_{c} in the object space. The vertical axis represents a respective radius R. The X axis represents the respective distance Z. As is an asymptote. FIG. 12 shows a respective distance from the front lens surface of the camera or the projector on the X axis.

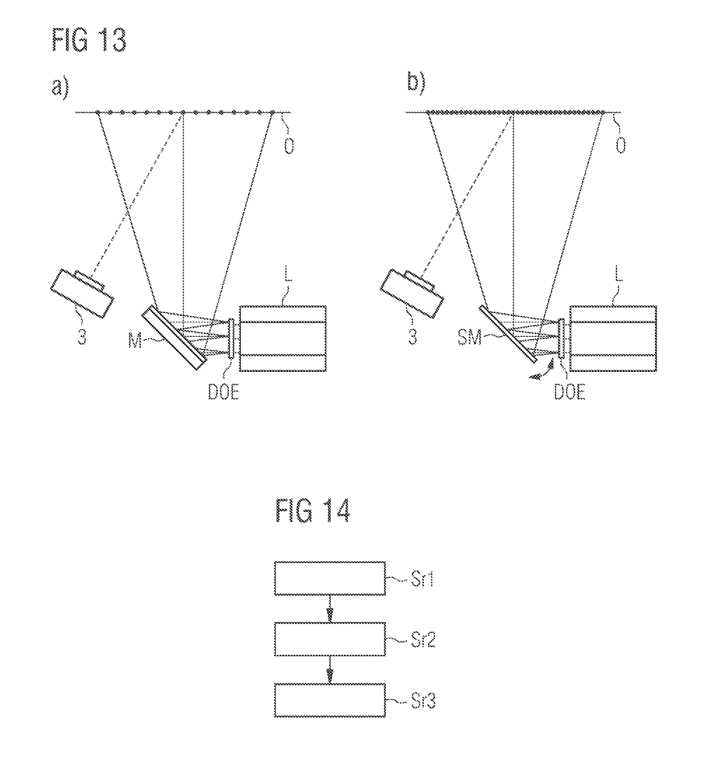

FIG. 13 shows two further exemplary embodiments of devices according to the teachings of the present disclosure. FIGS. 13a and 13b each comprise a light source L, a diffractive optical element DOE, a mirror M, and an acquisition unit 3. By means of a respective mirror M, a measurement pattern can be projected onto an object O and acquired by the acquisition unit 3. It has been recognized that the measurement point density can additionally be increased by a chronologically varying displacement of the measurement pattern projection of all mentioned assemblies. FIG. 13a shows a conventional stationary mirror M, wherein in contrast thereto, according to the exemplary embodiment according to FIG. 13b, the advantageous chronologically varying displacement can be executed by means of scanning methods. Accordingly, according to FIG. 13b, rotationally or translationally actuated components can be used, which can be, for example, a deflection mirror SM. The scanning mirror or deflection mirror SM can be rotatable in an angled surface.

FIG. 14 shows an exemplary embodiment of a method according to the teachings of the present disclosure. The method is used to reconstruct a surface of an object O by means of a structured illumination, wherein the following steps are executed. With a first step Sr1, a diffractive projection of measurement patterns consisting of measurement elements, in particular measurement points P, onto the surface of the object is performed, wherein the projector unit 1 projects a chronological sequence of measurement patterns consisting of measurement elements onto the surface of the project, wherein the chronological sequence of the measurement patterns, when superimposed, forms an overall pattern, in which all possible positions of measurement elements are represented and compiled in repeating groups, in which a respective combination of provided and/or non-provided measurement elements codes the respective location in the overall pattern. With a second step Sr2, an acquisition unit 3 acquires, simultaneously with step Sr1, the measurement patterns on the surface of the object. With a third step Sr3, the surface of the object can be reconstructed from a respective distortion of a measurement pattern by means of a computer unit. Triangulation is suitable in particular as a computation method or as a method for computing 3D coordinates.

What is claimed is:

1. A device for reconstruction of a surface of an object by means of a structured illumination, the device comprising:
a projector unit for diffractive projection of a measurement pattern comprising a plurality of measurement points onto the surface of the object;
an acquisition unit for acquiring the measurement pattern from the surface of the object; and
a computer unit for reconstruction of the surface of the object from a respective distortion of the measurement pattern;
wherein
all possible positions of measurement elements are contained in the measurement pattern in repeating groups in which a respective combination of measurement points represents a respective location in the measurement pattern.

2. The device as claimed in claim 1, wherein the projector unit projects the measurement pattern as a chronological sequence of measurement patterns onto the surface of the object,
and the chronological sequence of the measurement patterns forms an overall pattern when superimposed.

3. The device as claimed in claim 1, wherein the projector unit represents the respective location in the measurement pattern in the groups with a respective light wavelength of measurement points.

4. The device as claimed in claim 1, wherein the measurement pattern comprises a concatenation of hexagonal geometric basic shapes.

5. The device as claimed in claim 2, wherein the projector unit always generates all measurement points in at least one measurement pattern of the chronological sequence.

6. The device as claimed in claim 2, wherein:
the projector unit generates the chronological sequence of three measurement patterns;
a first measurement point is always generated in each group from one measurement pattern of the chronological sequence and at most two measurement points are generated from each of the two other measurement patterns of the chronological sequence.

7. The device as claimed in any claim 1, wherein the projector unit provides a maximum number of greater than four measurement points within the repeating groups.

8. The device as claimed in claim 1, wherein the projector unit only provides codings having a minimum number of measurement elements within the repeating groups.

9. The device as claimed in claim 1, wherein the projector unit generates the repeating groups overlapping such that each of a number of measurement points is both part of a group k and also part of an adjacent group k+1 or k−1.

10. The device as claimed in claim 1, wherein the projector unit generates a sequence of adjacent groups as a word.

11. The device as claimed in claim 10, wherein the projector unit generates an entirety of all adjacent groups as a sequence or as the overall pattern.

12. The device as claimed in claim 11, wherein the projector unit generates a word within a sequence or an overall pattern only often enough that the correspondence problem is uniquely solvable on the basis of geometric framework conditions between camera and projector, by means of epipolar geometry.

13. The device as claimed in claim 10, wherein the projector unit generates one word differently from another word in at least two of the repeating groups.

14. The device as claimed in claim 1, wherein the projector unit comprises, in a spatially separated manner, a light source, a beam-forming optic, and a diffractive optical element for each measurement pattern consisting of measurement points.

15. The device as claimed in claim 1, wherein the projector unit comprises, in a spatially compiled manner, at least one light source, at least one beam-forming optic, and at least two mechanically replaceable diffractive optical elements for all measurement patterns consisting of measurement points.

16. The device as claimed in claim 1, wherein the projector unit comprises at least one diffractive optical element from which a filter unit, for absorption or reflection of at least zero-order diffraction, is arranged downstream in the downstream beam path.

17. The device as claimed in claim 16, wherein the filter unit is spaced apart from the diffractive optical element such that a separation of the measurement elements occurs before the filter unit.

18. The device as claimed in claim 1, wherein the numeric aperture and the beam waist are adapted in the meaning of a Gaussian beam of the projector unit such that a radius of a projected beam is smaller than a radius of a camera pixel in the object space at least over the required depth of field range.

19. The device as claimed in claim 1, wherein the projector unit, to increase a measurement point density by means of a chronologically varying displacement of a respective measurement pattern comprises rotationally or translationally actuated components.

20. A method for reconstruction of a surface of an object by means of a structured illumination, the method comprising:
projecting a measurement pattern comprising measurement points onto the surface of the object with diffractive projection by a projector unit;
acquiring the measurement pattern on the surface of the object by means of an acquisition unit; and
computing a reconstruction of the surface of the object from a respective distortion of the measurement pattern by means triangulation;
wherein
all possible positions of measurement points are contained in the measurement pattern in repeating groups; and
a respective combination of measurement points represents a respective location in the measurement pattern.

21. The method as claimed in claim 20, further comprising projecting the measurement pattern as a chronological sequence of measurement patterns onto the surface of the object;
wherein the chronological sequence of the measurement patterns forms an overall pattern when superimposed.

22. The method as claimed in claim 20, further comprising representing a respective location in the measurement pattern in the repeated groups by a respective light wavelength of measurement points.

23. The method as claimed in claim 20, further comprising generating the measurement pattern as a concatenation of hexagonal geometric basic shapes.

24. The method as claimed in claim 21, wherein the projector unit always generates all measurement points in at least one measurement pattern of the chronological sequence.

25. The method as claimed in claim 20, further comprising generating a chronological sequence of three measurement patterns, wherein one measurement element is always generated in each group from a first measurement pattern of the chronological sequence and at most two measurement points are generated from each of the two other measurement patterns of the chronological sequence.

26. The method as claimed in claim 20, further comprising providing a maximum number of greater than four measurement points within the repeating groups.

27. The method as claimed in claim 20, further comprising only forming codings having a minimum number of measurement points within the repeating groups.

28. The method as claimed in claim 20, further comprising generating overlapping such that a number of measurement points are both part of a group k and also part of an adjacent group k+1 or k−1.

29. The method as claimed in claim 20, further comprising generating a sequence of adjacent groups as a word.

30. The method as claimed in claim 29, further comprising generating an entirety of all adjacent groups as a sequence or as the overall pattern.

31. The method as claimed in claim 30, further comprising generating a word within a sequence or an overall pattern only often enough that the correspondence problem is uniquely solvable on the basis of geometric framework conditions between camera and projector by means of epipolar geometry.

32. The method as claimed in claim 29, further comprising generating a first word differently from a second word in at least two groups.

33. The method as claimed in claim 20, further comprising removing a zero-order diffraction by absorption or reflection from a measurement space in the downstream beam path of a diffractive optical element by means of a light trap or deflection unit.

34. The method as claimed in any claim 20, further comprising adapting a numeric aperture and a beam waist in the meaning of a Gaussian beam of the projector unit such that a radius of a projected beam is smaller than a radius of a camera pixel in the object space at least over the required depth of field range.

35. The method as claimed in claim 20, further comprising executing executes a chronologically varying displacement of a respective measurement pattern, by means of rotationally or translationally actuated components, to increase a measurement point density.
